(19) United States
(12) Patent Application Publication
(10) Pub. No.: US 2012/0054539 A1
(43) Pub. Date: Mar. 1, 2012

(54) COMPUTING DEVICE AND RESTARTING METHOD OF THE COMPUTING DEVICE

(75) Inventor: YU-GANG ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/198,715

(22) Filed: Aug. 5, 2011

(30) Foreign Application Priority Data
Aug. 30, 2010 (CN) 201010266712.X

(51) Int. Cl. G06F 11/20

(52) U.S. Cl. 714/6.2; 714/E11.085

(57) ABSTRACT

A restarting method restarts a computing device when the computing device has a memory error. The computer device include a central processing unit (CPU) comprising a memory controller, a baseboard management controller (BMC) comprising a storage module, and a basic input output system (BIOS). The memory controller records error information of the memory module. A BMC reads the error information of the memory module from the memory controller of the CPU and saves the error information into a storage module of the BMC. The BIOS reads the error information from the storage of the BMC to determine a first memory module from the one or more memory modules that has a memory error. The BIOS sets a command in the CPU to avoid the memory controller to access the first memory module when the computing device is restarted.

### BACKGROUND

1. Technical Field

Embodiments of the present disclosure relate to computing device technology, and particularly to a computing device and a restarting method of the computing device.

2. Description of Related Art

In computing, memory refers to state information of a computing system. Usually, the memory is kept active in a memory module. The memory module is a necessary component of a computing device. When the computing device is turned on, the computing device accesses the memory module. However, in some situations, a memory error (e.g., a buffer overflow) may occur in the memory module. The memory errors may cause varying results in the computing device, from being simply annoying to being catastrophic. Furthermore, if the memory error is not removed from the memory module, the computing device cannot be restarted. Therefore, it would be inconvenient and time-wasting when the memory error occurs.

### BRIEF DESCRIPTION OF THE DRAWINGS

FIG. 1 is a system view of one embodiment of a system for restarting a computing device.

FIG. 2 is a block diagram of one embodiment of a computing device of FIG. 1.

FIG. 3 is a flowchart of one embodiment of a restarting method of a computing device.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computing device-readable medium or other storage device. Some non-limiting examples of non-transitory computing device-readable media include CDs, DVDs, BLU-RAY, flash memory, and hard disk drives.

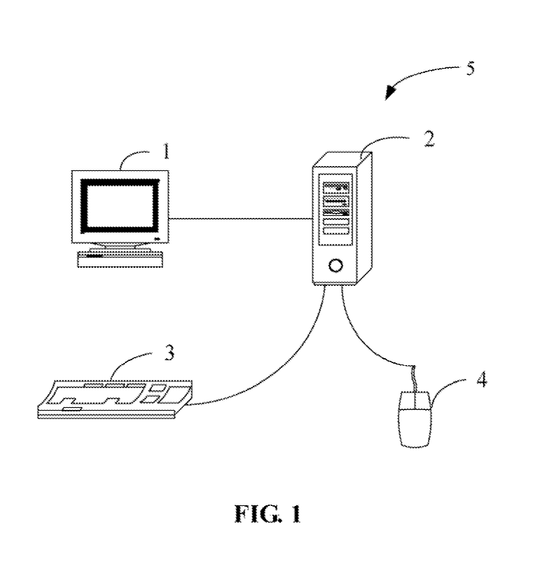

FIG. 1 is a block diagram of one embodiment of a computing system 5. The computing system includes a computing device 2 that includes a plurality of peripherals and devices electronically connected to the computing device 2. In one embodiment, the computing device 2 may be electronically connected to a display 1, a keyboard 3, and a mouse 4 in order to input/output various computing device signals or interfaces. In one embodiment, the computing device 2 may be a personal computer (PC), a network server, and can be any other appropriate data-processing equipment.

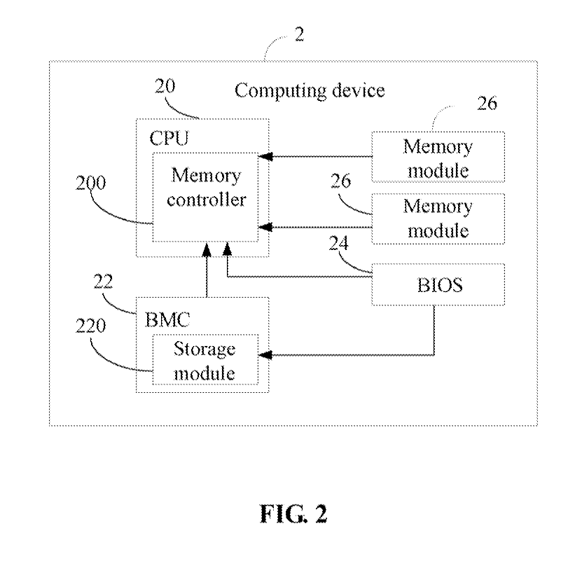

FIG. 2 is a block diagram of one embodiment of the computing device 2 in the FIG. 1. The computing device 2 includes a central processing unit (CPU) 20, a baseboard management controller (BMC) 22, a basic input output system (BIOS) 24, and one or more memory modules 26. The CPU 20 is connected to the BMC 22, the BIOS 24 and the memory modules 26. The BIOS 24 is connected to the BMC 22. In one embodiment, each memory module 26 includes a series of dynamic random access memory integrated circuits. Each memory module 26 is mounted on a printed circuit board and designed for the computing device 2. The one or more memory modules 26 may be, but are not limited to, a dual in-line memory module (DIMM) or a single in-line memory module (SIMM).

The CPU 20 includes a memory controller 200. The memory controller 200 controls the one or more memory modules 26 and records the information of the one or more memory modules 26. In one embodiment, the information of the one or more memory modules 26 includes a name of each memory module 26, a running speed (e.g., bit rate) of each memory module 26, a memory bank for each memory module 26, a memory slot corresponding to each memory module 26, and a data depth and width for each memory module 26. Additionally, if a memory error occurs in a memory module 26, the memory controller 200 further records error information of the memory module 26. The error information includes a name, a date, and a type of the memory error, such as an arithmetic overflow, a memory leak, a segmentation fault, or a buffer overflow.

The BMC 22 includes a storage module 220. The storage module 220 is used to save the error information of the one or more memory modules 26. In one embodiment, the BMC 22 reads the error information of the one or more memory modules 26 from the memory controller 200, and saves the error information of the one or more memory modules 26 into the storage module 220. In one embodiment, the storage module 220 may be a flash, a hard drive, or an electrically erasable programmable read-only memory (EEPROM).

The BIOS 24 reads the error information of the one or more memory modules 26 from the storage of the BMC to determine a first memory module 26 from the one or more memory modules 26 which the memory error occurs in. For example, the error information may be “A”, “2011-7-11”, “0x0007”, the BIOS 24 determines that A has the memory error.

The BIOS 24 further sets a command in the CPU 20 to prevent the memory controller 200 from accessing the first memory module 26 when the computing device 2 is restarted. The commands may be, but are not limited to, an on command and an off command. It should be noted that, in this embodiment, in the on command, the memory controller 200 can access the memory modules 26. In the off command, the memory controller 200 cannot access the memory modules 26. In one embodiment, assuming that the two memory modules 26 are labeled as A and B, if A has a memory error and B has no memory error, the BIOS 24 sets the off command in the CPU 20 for the memory module A and also sets the on command in the CPU 20 for the memory module B. The memory controller 200 accesses B and does not access A when the computing device 2 is restarted.

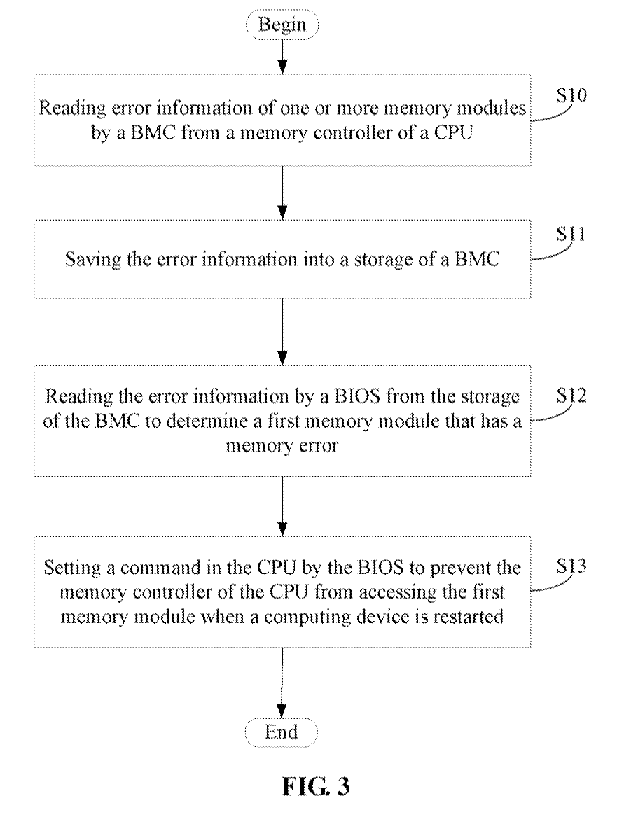

FIG. 3 is a flowchart of one embodiment of a restarting method of the computing device 2. Depending on the embodiment, additional blocks may be added, others deleted, and the ordering of the blocks may be changed.

In block S10, the BMC 22 reads the error information of the one or more memory modules 26 from the memory controller 200. As mentioned above, the error information may include a name, a date, a type of the memory error (e.g., an arithmetic overflow, a memory leak, a segmentation fault or a buffer overflow). For example, the error information may be “A”, “2011-7-11”, “0x0007”, where “A” is the name of the memory module 26, “2011-7-11” is the date and “0x0007” is the type of the memory error.

In block S11, the BMC 24 saves the error information of the one or more memory modules 26 into the storage module 220. In one embodiment, the storage module 220 may be a flash, a hard drive, or an electrically erasable programmable read-only memory (EEPROM).

In block S12, the BIOS 24 reads the error information of the one or more memory modules 26 from the storage of the BMC 24 to determine a first memory module 26 from the one or more memory modules 26 which the memory error occurs in. For example, the error information may be “A”, “2011-7-11”, “0x0007”, the BIOS 24 determines that A has the memory error from the one or more memory modules 26.

In block S13, the BIOS 24 sets a command in the CPU 20 to prevent the memory controller 200 from accessing the first memory module 26 when the computing device 2 is restarted. As mentioned above, if a memory error occurs in A and B has no the memory error, the BIOS 24 sets the off command in the CPU 20 for the memory module A and also sets the on command in the CPU 20 for the memory module B. The memory controller 200 accesses B and does not access A when the computing device 2 is restarted.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a central processing unit (CPU) comprising a memory controller;
a baseboard management controller (BMC) comprising a storage module;
a basic input output system (BIOS);
one or more memory modules;
the memory controller of the CPU operable to record error information of the one or more memory modules;
the BMC operable to read the error information from the memory controller and save the error information into the storage module of the BMC;
the BIOS operable to read the error information from the storage of the BMC to determine a first memory module from the one or more memory modules that has a memory error; and
the BIOS further operable to set a command in the CPU to prevent the memory controller from accessing the first memory module when the computing device is restarted.

2. The computing device of claim 1, wherein the memory module is a dual in-line memory module (DIMM) or a single in-line memory module (SIMM).

3. The computing device of claim 1, wherein storage module is selected from the group consisting of a flash, a hard drive, and an electrically erasable programmable read-only memory (EEPROM).

4. The computing device of claim 1, wherein the error information comprises a name of the memory module, a date, and a type of the memory error.

5. A restarting method of a computing device, the computing device comprising a central processing unit (CPU) comprising a memory controller, a baseboard management controller (BMC) comprising a storage module, a basic input output system (BIOS), and one or more memory modules, the method comprising:
recording error information of the one or more memory modules by the memory controller;
reading the error information by the BMC from the memory controller and saving the error information into the storage module of the BMC; and
reading the error information by a BIOS from the storage of the BMC to determine a first memory module from the one or more memory modules that has a memory error; and
setting a command in the CPU by the BIOS to prevent the memory controller of the CPU from accessing the first memory module when the computing device is restarted.

6. The method of claim 5, wherein the memory module is a dual in-line memory module (DIMM) or a single in-line memory module (SIMM).

7. The method of claim 5, wherein storage module is selected from the group consisting of a flash, a hard drive, and an electrically erasable programmable read-only memory (EEPROM).

8. The method of claim 5, wherein the error information comprises a name of the memory module, a date, a type of the memory error.

9. A non-transitory computing device-readable medium having stored thereon instructions that, when executed by a computing device, the computing device comprising a central processing unit (CPU) comprising a memory controller, a baseboard management controller (BMC) comprising a storage module, and a basic input output system (BIOS), causing the computing device to perform a restart method, the method comprising:
recording error information of the one or more memory modules by the memory controller;
reading the error information by the BMC from the memory controller and saving the error information into the storage module of the BMC; and
reading the error information by a BIOS from the storage of the BMC to determine a first memory module from the one or more memory modules that has a memory error; and
setting a command in the CPU by the BIOS to prevent the memory controller of the CPU from accessing the first memory module when the computing device is restarted.

10. The medium of claim 9, wherein the memory module is a dual in-line memory module (DIMM) or a single in-line memory module (SIMM).

11. The medium of claim 9, wherein storage module is selected from the group consisting of a flash, a hard drive, and an electrically erasable programmable read-only memory (EEPROM).

12. The medium of claim 9, wherein the error information comprises a name of the memory module, a date, a type of the memory error.
